(19) United States
(12) Patent Application Publication
(10) Pub. No.: US 2011/0272613 A1
(43) Pub. Date: Nov. 10, 2011

(54) VALVE ELEMENT MECHANISM FOR EXHAUST GAS CIRCULATION VALVE

(76) Inventors: Haruo Watanuki, Tokyo (JP); Satoru Hasegawa, Tokyo (JP); Sotsuo Miyoshi, Tokyo (JP)

(21) Appl. No.: 12/675,660

(22) PCT Filed: Jun. 30, 2008
(86) PCT No.: PCT/JP2008/001703

§ 371 Date: Feb. 26, 2010

(30) Foreign Application Priority Data
Nov. 28, 2007 (JP) 2007-307290

(51) Int. Cl. F16K 5/00

(52) U.S. Cl. 251/314; 251/304

(57) ABSTRACT

A valve element mechanism for an exhaust gas circulation valve has: a primary eccentricity A causing a center O of a support shaft 4 rotatably provided in a housing 2 to separate from a centerline P of a seal surface 2b of a valve seat 2a with which a valve element 5 opening and closing a fluid passage by being rotated by the support shaft 4 contacts; a secondary eccentricity B causing the center O of the support shaft 4 to separate from a centerline Q of the housing 2, and a tertiary eccentricity C causing an apex G of a cone shape 6 defining a seal surface 5a of the valve element 5 and the seal surface 2b of the valve sheet 2a to position at a side opposite from the support shaft 4 and to tilt against a centerline of the housing 2.

### TECHNICAL FIELD

The present invention relates to a valve element mechanism for an exhaust gas circulation valve, which is installed in an exhaust gas circulation valve for circulating an engine exhaust gas to an intake passage and used for opening and closing a flow passage.

### BACKGROUND ART

Conventionally, known as an exhaust gas circulation valve for circulating an engine exhaust gas to an intake passage are a poppet type valve adjusting the amount of circulation of an exhaust gas by the reciprocating movement of its valve element made by the reciprocating movement in an axial direction of its support shaft for supporting the valve, and a butterfly type valve adjusting the amount of circulation of an exhaust gas by the rotation of its valve element caused by the rotational movement about the axis, of its support shaft for supporting the valve element.

FIG. 7 is a view showing a composition of an exhaust gas circulation valve using a conventional butterfly type valve element, FIG. 7(a) is a sectional view thereof, and FIG. 7(b) is a sectional view taken along the line Z-Z of FIG. 7(a). A valve element 95 for adjusting the amount of an exhaust gas circulated through an exhaust gas circulation valve 9 is supported by a support shaft 93 for operating the valve element 95, and the support shaft 93 is supported by a bearing 92 provided within a housing 91 for forming an exhaust gas passage. Further, the valve element 95 is rotated by rotating the support shaft 93 with an actuator (not shown) supported by the housing 91, and thereby providing an opening passage between the valve element and a valve seat 94 supported by the housing 91 to adjust the amount of circulation of an exhaust gas.

Moreover, as shown in FIG. 7(a), in the conventional exhaust gas circulation valve 9, the valve element 95 rotates in the opening passage, and thus the entry angle D of the valve element 95 when the seal surface 95a of the valve element 95 contacts the seal surface 94a of the valve seat 94 at the time of closing of the valve element 95 becomes substantially 0 degrees. The exhaust gas contains particle materials such as soot and the like, and those particle materials are deposited over the inner wall surface of the opening passage or the valve seat 94. Thus, when the entry angle D of the valve element 95 at the time of contact of the valve element with the seal surface 94a of the valve seat 94 is 0 degrees, there are some cases that the particle materials get stuck between the valve seat 94 and the valve element 95 to thus interfere with the opening and closing operation of the valve element 95.

For countermeasures against this drawback, in an exhaust gas circulation valve 9 using a butterfly type valve element shown in FIG. 8, it is arranged that a valve seat 94b contacting a valve element 95 is formed in a generally L shape such that the entry angle of the valve element 95 is about 90 degrees when the seal surface 95c of the valve element 95 contacts the seal surface 94c of the valve seat 94b at the time of closing of the valve element 95.

Since the conventional butterfly type valve elements are arranged as described above, there is a problem that the particle materials get stuck between the valve seat and the valve element at the time of closing of the valve element to interfere with the opening and closing operation of the valve element, or there is a problem that since the axis of the shaft is situated above the valve seat, a seal surface for between the valve seat and the valve element cannot be formed, which would make it difficult to ensure gas-tightness at the time of closing of the valve element.

The present invention has been made to solve the above-mentioned problems, and an object of the present invention is to improve the gas-tightly operating characteristic of a valve element by maintaining the entry angle of the valve element to a valve seat at a predetermined value and also to restrain leakage of an exhaust gas during the valve element is closed by providing a seal surface on the axis of the valve seat.

### DISCLOSURE OF THE INVENTION

The valve element mechanism for an exhaust gas circulation valve according to the present invention includes a housing having a fluid passage formed of tubular, a support shaft rotatably provided within the housing, a valve seat formed within the housing, and a valve element for opening and closing the fluid passage by being rotated by the support shaft, the valve element mechanism comprising: a primary eccentricity causing a center of the support shaft to separate from a centerline of a seal surface of the valve seat with which the valve element contacts; a secondary eccentricity causing the center of the support shaft to separate from a center of the outer periphery of the valve element; and a tertiary eccentricity causing an apex of a cone shape defining a seal surface of the valve element and the seal surface of the valve seat to position at a side opposite from the support shaft and to tilt against a centerline of the housing.

According to the present invention, the valve element mechanism for an exhaust gas circulation valve is arranged to have the primary eccentricity for separating or decentering the centerline of the support shaft from the centerline of the seal surface of the valve seat with which the valve element comes into contact; the secondary eccentricity for separating or decentering the center of the support shaft from the center of the outer periphery of the valve element; and the tertiary eccentricity for positioning the apex of the circular conical shape defining the seal surface of the valve element and the seal surface of the valve seat on the side opposite from the support shaft and also for tilting the apex thereof relative to the centerline of the housing, and thus the tightly operating characteristic of the valve seat with the valve element at the time of closing of the valve element can be enhanced. Further, the particle materials can not be stuck at the time of closing of the valve element, and the smooth opening and closing operation of the valve element can be maintained.

### BRIEF DESCRIPTION OF THE DRAWINGS

FIG. 1 is a view showing a valve element mechanism for an exhaust gas circulation valve in accordance with the first embodiment of the present invention.

FIG. 2 is a view conceptually showing the triple-eccentric shape of the valve element mechanism for an exhaust gas circulation valve in accordance with the first embodiment of the present invention.

FIG. 3 is a view showing a valve closing operation of the valve element mechanism for an exhaust gas circulation valve in accordance with the first embodiment of the present invention.

FIG. 4 is a view showing another composition of the valve element mechanism for an exhaust gas circulation valve in accordance with the first embodiment of the present invention.

FIG. 5 is a view showing a composition of a valve element mechanism for an exhaust gas circulation valve in accordance with the second embodiment of the present invention.

FIG. 6 is an explanatory view showing the composition of the valve element mechanism for an exhaust gas circulation valve in accordance with the second embodiment of the present invention.

FIG. 7 is a view showing a composition of a conventional butterfly valve.

FIG. 8 is a view showing a composition of a conventional butterfly valve.

### BEST MODE FOR CARRYING OUT THE INVENTION

Embodiments of the present invention will now be described with reference to the accompanying drawings in order to explain the present invention in more detail.

### First Embodiment

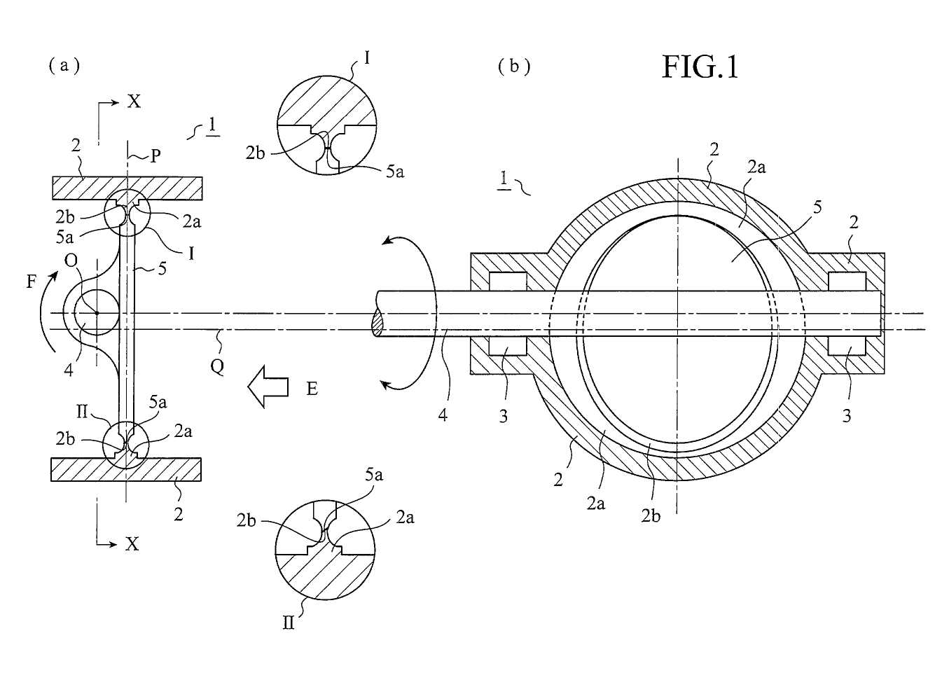

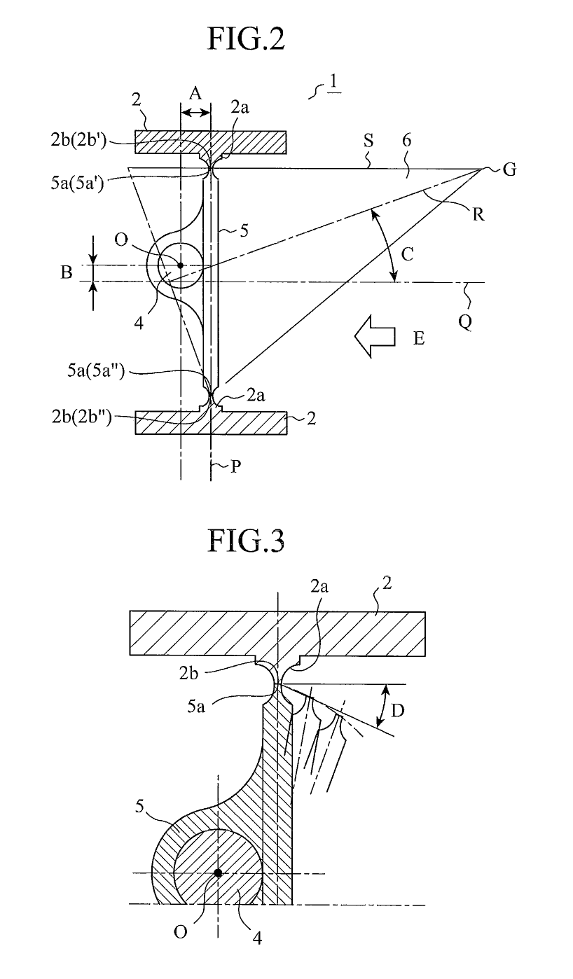

FIG. 1 is a view showing a valve element mechanism for an exhaust gas circulation valve in accordance with the first embodiment of the present invention, FIG. 1(a) is a sectional view thereof, and FIG. 1(b) is a sectional view taken along the line X-X of FIG. 1(a). FIG. 2 is a view conceptually showing the triple-eccentric shape of the valve element mechanism for an exhaust gas circulation valve in accordance with the first embodiment of the present invention.

The composition of the valve element mechanism for an exhaust gas circulation valve in accordance with the first embodiment will be discussed with reference to FIG. 1 and FIG. 2. An exhaust gas circulation valve 1 has a housing 2 substantially formed of tubular therein. A flow passage within the housing 2 is equipped with a valve element 5 of disk-shape which is rotatably journaled on a support shaft 4 by a bearing 3. One end of the support shaft 4 extends to the outside of the exhaust gas circulation valve 1, is coupled with an actuator (not shown), and rotates and drives the valve element 5 with the driving force of the actuator. A fluid passage within the housing 2 is opened and closed by the rotation of the valve element 5 together with the support shaft 4. In this context, the support shaft 4 is plated with chromium or the like over the surface thereof.

A valve seat 2a projecting from the surface along a diametric direction is integrally molded on the inner peripheral surface of the fluid passage of the housing 2. The valve seat 2a has a tapered shape, and the tip of the tapered shape is provided with a seal surface 2b for tightly contacting the valve element 5. Meanwhile, the valve element 5 has a tapered shape along the outer periphery thereof, and the tip of the tapered shape is equipped with a seal surface 5a for tightly contacting the valve seat 2a. When the valve element 5 is closed, the seal surface 2b of the valve seat 2a and the seal surface 5a of the valve element 5 are brought into tight contact with each other to close the flow passage. It is arranged that the tightly contacting portions of the seal surface 2b and the seal surface 5a have the same width. In sections I and II of FIG. 1(a), the compositions of the seal surface 2b and the seal surface 5a are shown on an enlarged scale (hereinafter, omitted in other figures).

The exhaust gas circulation valve 1 has a triple-eccentric shape where the housing 2, the support shaft 4, and the valve element 5 each have a center decentered relative to each other. As shown in FIG. 2, the exhaust gas circulation valve 1 is applied by the triple-eccentric shape defined by a primary eccentricity A, a secondary eccentricity B, and a tertiary eccentricity C. The primary eccentricity A causes the center O of the support shaft 4 as a rotating shaft to separate from the centerline P of the contact surface between the seal surface 2b of the valve seat 2a and the seal surface 5a of the valve element 5. The secondary eccentricity B causes the center O of the support shaft 4 to separate from the centerline Q of the valve seat 2a and the seal surface 5a of the valve element 5 before applied the triple eccentricity, in other words, the centerline Q in the outer periphery of the valve element 5 (the centerline Q of the housing 2). The tertiary eccentricity C causes the centerline R of a cone shape 6 defining the contact surface between the seal surface 2b of the valve seat 2a and the seal surface 5a of the valve element 5 to tilt against the centerline Q of the housing 2. By the triple-eccentric shape, the support shaft 4 is disposed so as to be located at the downstream side with respect to the flow E of the circulating exhaust gas.

The seal surface 2b of the valve seat 2a and the seal surface 5a of the valve element 5 each have a substantially elliptical shape formed when the cone shape 6 defined by the primary eccentricity A, the secondary eccentricity B, and the tertiary eccentricity C is obliquely cut. Further, the seal surface 2b and the seal surface 5a each are of minor diameter in the substantially elliptical shape in a parallel direction to the support shaft 4 and are of major diameter in the substantially elliptical shape in a perpendicular direction to the support shaft 4. The seal surface 2b and the seal surface 5a have a generally elliptical shape formed by obliquely cutting the cone shape 6, and thus a parallel section where the contact surface between the seal surface 2b and the seal surface 5a perpendicularly intersects the centerline P of the valve element 5, and a taper section where the contact surface between the seal surface 2b and the seal surface 5a intersects the centerline P of the valve element 5 at an acute angle are formed. To be more specific, in FIG. 2, the parallel sections (2b′, 5a′) are formed in the upper portion of the valve element 5, and the taper sections (2b″, 5a″) having the maximum inclination in the lower portion of the valve element 5 where 180 degrees opposite from the parallel sections (2b′, 5a′) are formed.

On each of the seal surface 2b and the seal surface 5a, a taper surface continuously increasing the angle of inclination from the parallel sections (2b′, 5a′) toward the taper sections (2b″, 5a″) is formed. By the structure, the seal surface 2b and the seal surface 5a can be provided throughout the inner peripheral surface of the flow passage of the housing 2. Moreover, by forming the seal surface 2b and the seal surface 5a in a substantially elliptical shape, the engagement and disengagement of the valve element 5 to the valve seat 2a can be smoothly performed. In addition, the cone shape 6 has an apex G as shown in FIG. 2, and the apex G is situated on the tangent S to the seal surface 2b and the seal surface 5a in the parallel sections (2b′, 5a′). The tangent S is parallel to the centerline Q of the housing 2.

Furthermore, the seal surface 2b and the seal surface 5a each have or define the same substantially elliptical shape; however, the seal surface 2b is arranged to have an inner diameter slightly larger than the outer diameter of the seal surface 5a. On the seal surface 2b formed on the housing 2 exposed to the outside air and the seal surface 5a formed on the valve element 5 that does not contact the outside air, there is a difference in the rate of expansion caused by the heat of the circulating exhaust gas, however, the above structure can cancel off the difference in the rate of expansion. Thereby, the fitting characteristic of the valve element 5 to the valve seat 2a can be improved without greatly losing the gas-tightness therebetween.

FIG. 3 is a view showing a valve closing operation of the valve element mechanism for an exhaust gas circulation valve in accordance with the first embodiment of the present invention. Entry angle D indicates the entry angle of the valve element 5 when the seal surface 5a of the valve element 5 tightly contacts the seal surface 2b of the valve seat 2a. By setting the entry angle D at 5 degrees or more and 80 degrees or less, the gas-tightly operating characteristic between the valve seat 2a and the valve element 5 at the time of closing of the valve element 5 can be improved. Moreover, by setting the entry angle D at 5 degrees or more and 80 degrees or less, the particle materials contained in the circulating exhaust gas can be prevented from being stuck between the seal surface 2b and the seal surface 5a at the time of closing of the valve element 5, thus achieving the smooth operation opening and closing operation of the valve element 5.

Meanwhile as shown in FIG. 1, the valve element 5 of triple-eccentric shape is formed by a secondary eccentricity B for decentering the center O of the support shaft 4 from the centerline Q of the valve seat 2a and the seal surface 5a of the valve element 5 before performing the triple eccentricity, in other words, the centerline Q in the outer periphery of the valve element 5 (the centerline Q of the housing 2), and a tertiary eccentricity C for tilting the centerline R of the cone shape 6 defining the seal surface 5a of the valve element 5 from the centerline Q of the housing 2, and thus the valve element 5 has an asymmetrical shape relative to the support shaft 4. For this reason, as shown in FIG. 1(a), torque F is exerted on the support shaft 4 as the result of the face pressure received by the valve element 5 from the flow E of the circulating exhaust gas circulating in the housing 2, and thereby the torque is exerted thereon in a direction to open the valve element 5. Generally, it is preferable that the torque exerted on the valve element 5 is smaller than the force for automatically closing the valve, and thus it is necessary to reduce the torque F.

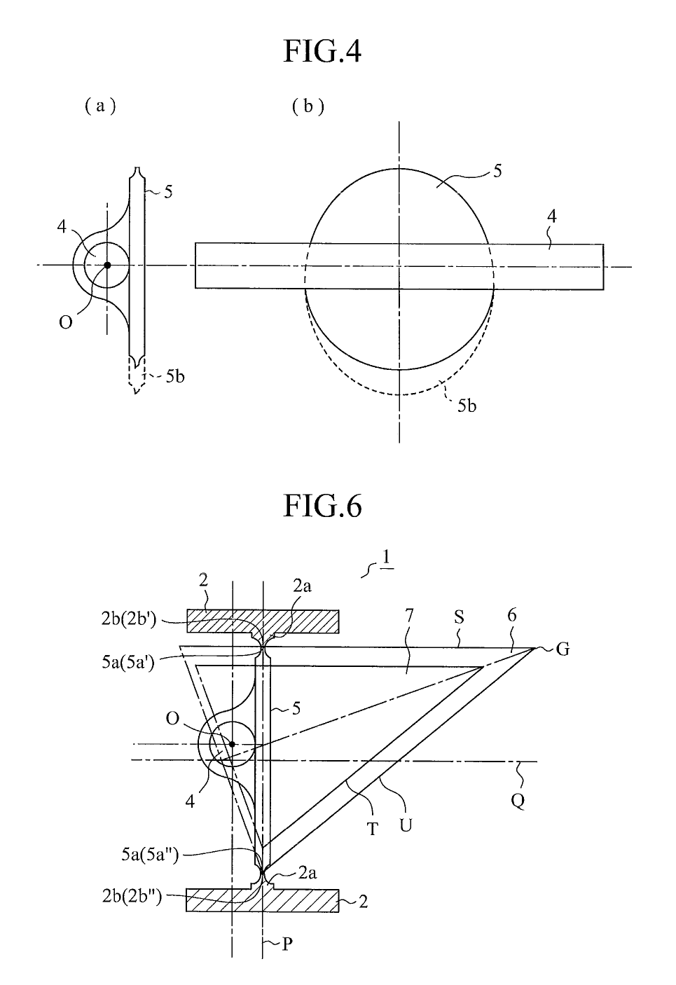

Then, the structure for suppressing the torque F exerted on the valve element 5 will be shown. FIG. 4 is a view showing another composition of the valve element mechanism for an exhaust gas circulation valve in accordance with the first embodiment of the present invention, FIG. 4(a) is a sectional view thereof, and FIG. 4(b) is a front view of the valve element.

In the composition shown in FIG. 4, the valve element edge 5b located on the side having a larger area (the lower portion of the valve element 5 in FIG. 4) defined by the support shaft 4 as a centerline is removed. By composing the valve element 5 by removing the valve element edge 5b such that the torque F exerted on the support shaft 4 by the face pressure received by the valve element 5 is canceled out or reduced below a predetermined value, the face pressure received from the flow E of the circulating exhaust gas can be balanced. Further, upon the deletion of the valve element edge 5b, the amount of projection of the valve seat 2a is increased so as to compensate the amount of reduction of the valve body edge 5b, thus providing forming the valve seat such that the seal surface 2b of valve seat 2a tightly contacts the seal surface 5a of the valve element 5.

Furthermore, when an automatically valve closing mechanism (not shown) for automatically closing the valve element 5 is provided in the exhaust gas circulation valve 1, the torque F exerted on the valve element 5 may be adjusted so as to become smaller than the automatic valve closing force of the automatically valve closing mechanism by adjusting the amount of removal of the valve element edge 5b. Moreover, in FIG. 1, the support shaft 4 is disposed on the downstream side with respect to the flow E of the circulating exhaust gas; however, when a higher priority is placed on the automatically valve closing force of the valve element 5, by adjusting the areas of the upper side portion and the lower side portion of the valve element 5 with the support shaft 4, it may be arranged that the torque exerted on the valve element 5 be exerted thereon in the opposite direction to the torque F shown in FIG. 1. Besides, when the eccentric shape is formed, by increasing the amount of eccentricity of the primary eccentricity A so as to be larger than the radius of the support shaft 4 and further reducing the amount of eccentricity of the secondary eccentricity B so as to be smaller than that of the primary eccentricity A, the torque F exerted on the support shaft 4 is suppressed to the minimum.

As discussed above, in accordance with the first embodiment, the valve element mechanism for an exhaust gas circulation valve is arranged by a triple-eccentric shape, and thus the seal surface of the valve seat and the seal surface of the valve element each forming a circumference within the housing can be provided.

Furthermore, in accordance with the first embodiment, by setting the entry angle of the valve element when the seal surface of the valve element tightly contacts the seal surface of the valve seat at 5 degrees or more and 80 degrees or less, the tightly operating characteristic between the valve seat and the valve element at the time of closing of the valve element can be improved. Furthermore, the particle materials contained in the circulating exhaust gas can be prevented from being stuck between the valve element and the valve seat at the time of closing of the valve element, and thus a smooth opening and closing operation of the valve element can be maintained.

Moreover, in accordance with the first embodiment, the support shaft is arranged to be disposed on the downstream side with respect to the flow of the circulating exhaust gas, and thus the soot or the like contained in the circulating exhaust gas is prevented from entering the bearing section of the support shaft or other sections, enabling a smooth opening and closing operation of the valve element to be continued.

Additionally, in accordance with the first embodiment, the valve seat is arranged to project inwardly from the housing, it becomes easy to process the seal surface of the valve seat. Further, the seal surfaces of the valve seat and the valve element are arranged to have substantially the same width to each other, process time for working each seal surface can be minimized.

Moreover, in accordance with the first embodiment, as to the valve element having a triple-eccentric shape asymmetrical relative to the support shaft, since the edge of the valve element on the side where the valve element has a larger area with respect to the support shaft as the center is removed, the torque exerted on the support shaft by the face pressure received by the valve element from the flow of the circulating exhaust gas, can be adjusted. Furthermore, even under high pressure in the exhaust gas circulation valve, the valve element can be operated at any opening with a small driving force.

In addition, in accordance with the first embodiment, the support shaft is arranged to be plated with chromium or the like over the surface thereof, and thus the deposition of the soot or the like contained in the circulating exhaust gas over the support shaft is reduced.

In the first embodiment discussed above, the edge of the valve element on the side where the valve element has a larger area with respect to the support shaft as the center is arranged to be removed; however, the edge of the valve element on the side where the element has a smaller area with respect to the support shaft as the center is arranged to be expanded to increase the area thereof. Also in that case, the face pressure received by the valve element becomes uniform, thus enabling the torque exerted on the support shaft to be adjusted.

### Second Embodiment

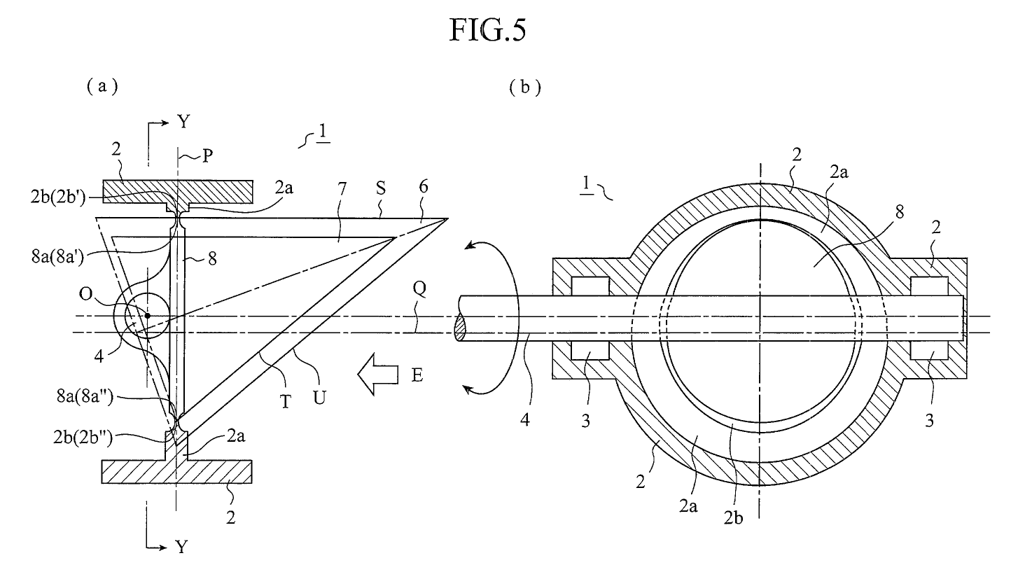

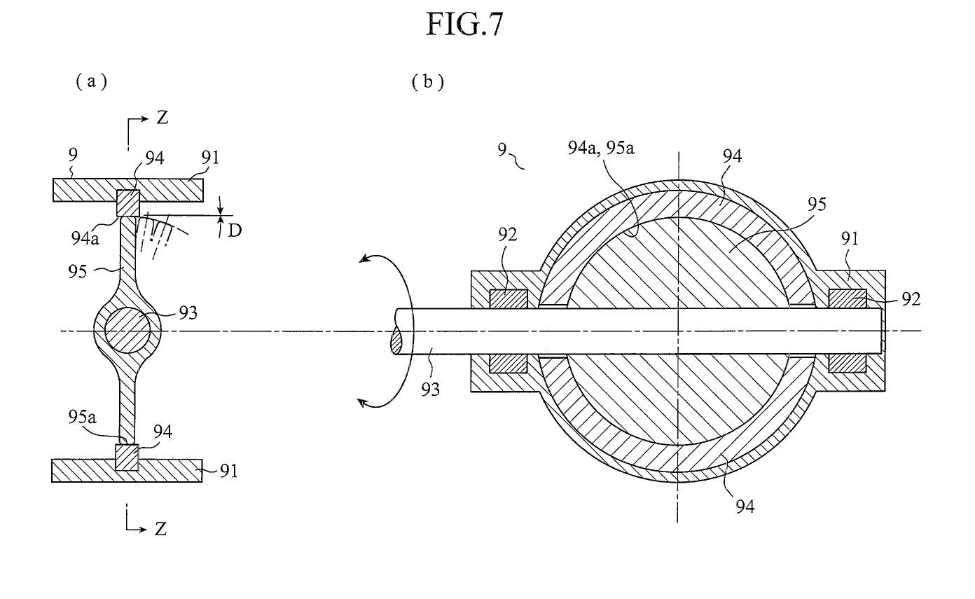

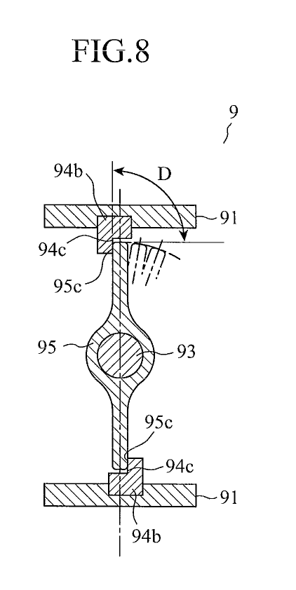

In the first embodiment mentioned above, the arrangement where the valve element edge is removed in order to adjust the torque exerted on the support shaft is shown; however, in the valve element mechanism for an exhaust gas circulation valve in accordance with the second embodiment, the arrangement is shown where the torque exerted on the support shaft is suppressed by a circularly conical shape similar to a cone shape formed by triple eccentricity. FIG. 5 is a view showing a composition of a valve element mechanism for an exhaust gas circulation valve in accordance with the second embodiment, FIG. 5(a) is a sectional view thereof, and FIG. 5(b) is a sectional view taken along the line Y-Y of FIG. 5(a). In passing, FIG. 6 is a view showing a composition of the valve element mechanism for an exhaust gas circulation valve in accordance with the first embodiment, and the figure is shown to clearly demonstrate the difference between the first embodiment and the second one. Hereinbelow, the same parts as the constituent elements of the valve element mechanism for an exhaust gas circulation valve in accordance with the first embodiment are provided by the same numerals as those used in the first embodiment and explanation is omitted or simplified.

FIG. 5(a) shows a first cone shape 6 and a second cone shape 7. The first cone shape 6 shows a cone shape formed by the triple eccentricity shown in the first embodiment discussed above. Meanwhile, the second cone shape 7 in accordance with the second embodiment is a cone shape having a shape similar to but smaller than the first cone shape 6. The apex of the second cone shape 7 is located on the centerline of the cone shape 6 and has the inclination of triple eccentricity similar to that of the cone shape 6.

As shown in FIG. 5(a), the second cone shape 7 has a tangent S to the parallel section (2b′) of the seal surface 2b of the valve seat 2a and the parallel section (8a′) of the seal surface 8a of the valve element 8 extending in a vertical direction to the centerline P of the valve element 8. Similarly, as shown in FIG. 6, the first cone shape 6 also has a tangent S to the parallel section (2b′) of the seal surface 2b of the valve seat 2a and the parallel section (5a′) of the seal surface 5a of the valve element 5 extending in a vertical direction to the centerline P of the valve element 5. In other words, the position of the parallel section (8a′) of the seal surface 8a of the valve element 8 in accordance with the second embodiment is the same as that of the parallel section (5a′) of the seal surface 5a of the valve element 5 in accordance with the first embodiment.

On the other hand, tangent T, forming the second cone shape 7, to the taper sections (2b″, 8a″) of the seal surface 2b of the valve seat 2a and the seal surface 8a of the valve element 8, having the maximum inclination, is arranged to be located inwardly in the first cone shape 6, from tangent U, forming the first cone shape 6, to the taper sections (2b″, 5a″) of the seal surface 2b of the valve seat 2a and the seal surface 5a of the valve element 5, having the maximum inclination. The second cone shape 7 and the first cone shape 6 have a similar shape to each other, and thus the tangent T and the tangent U are parallel to each other.

As shown in FIG. 5(a), the valve element 8 is formed so as to be inscribed in the second cone shape 7 smaller than the first cone shape 6, and thus the valve element 8 has an outer diameter smaller than that of the valve element 5. In comparison with the valve element 5 shown in FIG. 6, the outer radius of the valve element 8 decreases gradually and continuously from the parallel section (8a′) of the seal surface 8a of the valve element 8 toward the taper section (8a″) having the maximum inclination. As the valve element 8 has a reduced outer radius, the valve seat 2a gradually increases in the amount of projection from the parallel section (2b′) of the seal surface 2b toward the taper section (2b″) having the maximum inclination. In short, the amount of projection of the valve seat 2 in the second embodiment is larger than that of the valve seat 2 in the first embodiment. Additionally as with the first embodiment, the seal surface 2b is arranged to have an inner diameter slightly larger than the outer diameter of the seal surface 8a, thus improving the fitting characteristic of the valve element 8 with the valve seat 2a. Further, the tightly contacting portions of the seal surface 2b and the seal surface 8a are arranged to have the same width to each other.

The seal surface 2b of the valve seat 2a and the seal surface 8a of the valve element 8 each have a substantially elliptical shape formed when the second cone shape 7 is obliquely cut. The substantially elliptical shape is shown in FIG. 5(b). The second cone shape 7 is smaller than the first cone shape 6. Thus, not only the internal diameter of the seal surface 2b and the outer diameter of the seal surface 8a are smaller in comparison with those in the substantially elliptical shape shown in FIG. 1(b), but also asymmetry of the area of the upper side and that of the lower side of the valve element 8 with respect to the support shaft 4 as the centerline is reduced. Thereby, the torque F exerted on the support shaft 4 by the face pressure received by the valve element 8 from the flow E of the circulating exhaust gas circulating in the housing 2 can be adjusted.

Further, the first cone shape 6 and the second cone shape 7 are in the similarity shape. Thus, the entry angle D of the valve element 8 when the seal surface 2b of the valve seat 2a and the seal surface 8a of the valve element 8 tightly contact each other can be set at 5 degrees or more and 80 degrees or less, and the tightly contacting characteristic between the valve seat 2a and the valve element 8 is not deteriorated.

As discussed above, in accordance with the second embodiment, it is arranged that the second cone shape having a shape similar to the first cone shape formed by the triple eccentricity, and each of the seal surfaces of the valve seat and the valve element is formed along a general ellipse formed when the second cone shape is obliquely cut. Thus, setting the entry angle of the valve element relative to the valve seat at a predetermined value or more becomes possible, and the tightly contacting characteristic of the valve seat with the valve element is not deteriorated. Furthermore, the asymmetry of the valve element with the support shaft as the center reduces, and thus the face pressure received by the valve element from the flow of the circulating exhaust gas can be made uniform, enabling the torque exerted on the support shaft to be suppressed to the minimum.

### INDUSTRIAL APPLICABILITY

As discussed above, the valve element mechanism for an exhaust gas circulation valve according to the present invention is arranged such that the tightly operating characteristic between the valve seat and the valve element at the time of closing of the valve element is enhanced by the triple-eccentric structure, particle materials are prevented from being stuck at the time of closing of the valve element, and a smoothly opening and closing operation of the valve element can be maintained and thereby circulate the exhaust gas to the intake passage without leaking the gas. Thus, the valve element mechanism for an exhaust gas circulation valve is suitable for use in an exhaust gas circulation valve for a vehicle or the equivalent.

1. A valve element mechanism for an exhaust gas circulation valve including a housing having a fluid passage formed of tubular, a support shaft rotatably provided within the housing, a valve seat formed within the housing, and a valve element for opening and closing the fluid passage by being rotated by the support shaft, comprising:
a primary eccentricity causing a center of the support shaft to separate from a centerline of a seal surface of the valve seat with which the valve element contacts;
a secondary eccentricity causing the center of the support shaft to separate from a center of the outer periphery of the valve element; and
a tertiary eccentricity causing an apex of a cone shape defining a seal surface of the valve element and the seal surface of the valve seat to position at a side opposite from the support shaft and to tilt against a centerline of the housing,
wherein the valve element is removed an edge of a portion having a larger area defined by the support shaft as a center.

2. The valve element mechanism for an exhaust gas circulation valve according to claim 1, wherein the valve element is applied an entry angle into the seal surface of the valve seat at 5 degrees or more and 80 degrees or less.

3. (canceled)

4. (canceled)

5. The valve element mechanism for an exhaust gas circulation valve according to claim 1, wherein the seal surface of the valve element and the seal surface of the valve seat are defined by combining the cone shape and a portion of a second cone shape similar to said cone shape.

6. The valve element mechanism for an exhaust gas circulation valve according to claim 1, wherein an amount of separation defined by the primary eccentricity is larger than or equal to the radius of the support shaft, and an amount of separation defined by the secondary eccentricity is smaller than or equal to that of the primary eccentricity.

7. The valve element mechanism for an exhaust gas circulation valve according to claim 1, wherein an inner diameter of the seal surface of the valve seat is larger than an outer diameter of the seal surface of the valve element.

8. The valve element mechanism for an exhaust gas circulation valve according to claim 1, wherein the support shaft is disposed at a downstream side with respect to a flowing direction of a fluid in the housing.

9. The valve element mechanism for an exhaust gas circulation valve according to claim 1, wherein the seal surface of the valve seat projects from the housing along a diametric direction.

10. The valve element mechanism for an exhaust gas circulation valve according to claim 9, wherein the seal surface of the valve element and the seal surface of the valve seat have substantially the same width to each other.

11. The valve element mechanism for an exhaust gas circulation valve according to claim 1, wherein the support shaft is plated over a surface thereof.

12. A valve element mechanism for an exhaust gas circulation valve including a housing having a fluid passage formed of tubular, a support shaft rotatably provided within the housing, a valve seat formed within the housing, and a valve element for opening and closing the fluid passage by being rotated by the support shaft, comprising:
a primary eccentricity causing a center of the support shaft to separate from a centerline of a seal surface of the valve seat with which the valve element contacts;
a secondary eccentricity causing the center of the support shaft to separate from a center of the outer periphery of the valve element; and
a tertiary eccentricity causing an apex of a cone shape defining a seal surface of the valve element and the seal surface of the valve seat to position at a side opposite from the support shaft and to tilt against a centerline or the housing,
wherein the valve element is expanded an edge of a portion having a smaller area defined by the support shaft as a center.

13. The valve element mechanism for an exhaust gas circulation valve according to claim 12, wherein the valve element is applied an entry angle into the seal surface of the valve seat at 5 degrees or more and 80 degrees or less.

14. The valve element mechanism for an exhaust gas circulation valve according to claim 12, wherein the seal surface of the valve element and the seal surface of the valve seat are defined by combining the cone shape and a portion of a second cone shape similar to said cone shape.

15. The valve element mechanism for an exhaust gas circulation valve according to claim 12, wherein an amount of separation defined by the primary eccentricity is larger than or equal to the radius of the support shaft, and an amount of separation defined by the secondary eccentricity is smaller than or equal to that of the primary eccentricity.

16. The valve element mechanism for an exhaust gas circulation valve according to claim 12, wherein an inner diameter of the seal surface of the valve seat is larger than an outer diameter of the seal surface of the valve element.

17. The valve element mechanism for an exhaust gas circulation valve according to claim 12, wherein the support shaft is disposed at a downstream side with respect to a flowing direction of a fluid in the housing.

18. The valve element mechanism for an exhaust gas circulation valve according to claim 12, wherein the seal surface of the valve seat projects from the housing along a diametric direction.

19. The valve element mechanism for an exhaust gas circulation valve according to claim 18, wherein the seal surface of the valve element and the seal surface of the valve seat have substantially the same width to each other.

20. The valve element mechanism for an exhaust gas circulation valve according to claim 12, wherein the support shaft is plated over a surface thereof.
